(19) United States
(12) Patent Application Publication
(10) Pub. No.: US 2015/0284058 A1
(43) Pub. Date: Oct. 8, 2015

(54) ANTI-BIOFOULING, FLUID DYNAMIC EFFICIENT SURFACE COVERING FOR STRUCTURES AND METHOD OF MANUFACTURING

(71) Applicant: Florida Institute of Technology, Inc., Melbourne, FL (US)

(72) Inventors: Geoffrey W. Swain, Melbourne, FL (US); John Travis Hunsucker, Melbourne Beach, FL (US)

(21) Appl. No.: 14/682,082

(22) Filed: Apr. 8, 2015

Related U.S. Application Data
(60) Provisional application No. 61/977,056, filed on Apr. 8, 2014.

(51) Int. Cl. B63B 59/04; B05D 5/00

(52) U.S. Cl. CPC B63B 59/045; B05D 5/00

(57) ABSTRACT

This invention combines novel materials to provide improved fluid dynamic, biofouling and corrosion control to structures, for example ship stabilizer fins, by applying a novel multilayered conformal covering to such structures. The covering may further comprise drag-reducing control surfaces such as grooves, crests and troughs that improve the hydrodynamic characteristics of the structure. The invention may be comprised of two layers: an inner layer comprising an fabric, composite, elastomeric, or combination thereof, material to provide shape and a firm fit to the existing body and an outer layer comprising silicone based polymer to prevent or control biological growth. The properties of the inner layer, which may be stiff or elastomeric, are selected to provide a tough conformal fit over the structure to be improved and may be made from an fabric, composite or elastomer, or combinations thereof, such as neoprene or high modulus toughened silicone.

### CROSS REFERENCE TO RELATED APPLICATIONS

This non-provisional application for patent is filed in the United States Patent and Trademark Office (USPTO) under 35 U.S.C. §111(a), and is a non-provisional of, and claims the benefit of, U.S. Provisional Application Ser. No. 61/977,056, filed Apr. 8, 2014 in the USPTO which is incorporated herein by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention generally relates to the field of providing fluid dynamic, anti-biofouling and corrosion control surfaces to structures such as, for example, ship stabilizer fins, hulls, and any other structures that may experience bio-fouling or corrosion in the environments in which they are utilized. The application also relates to the field of fluid dynamic surface coverings that may cover structures such as ship stabilizers, hulls, vortex shedding devices and other surfaces that are utilized in a fluid dynamic environment. The application also relates to the field of retrofitable coverings for structures such as, for example, ship stabilizer fins, hulls, vortex shedding devices, and other structures which may from time to time have a need for refurbishment or retrofitting for any reason.

2. Background Art

The use of roll stabilizers is known in the art of ship design and building. Ship stabilizers typically take the form of fins or rotors mounted beneath a ship's waterline and emerging laterally into the water. In contemporary vessels, they may be fixed fins, movable fins, translatable or rotatable fins, or gyroscopically controlled active fins which have the capacity to change their angle of attack to counteract roll caused by wind or waves acting on the ship.

Ship stabilizer fins work by producing lift or down force when the vessel is in motion. Thus, these fins are vastly more efficient at higher velocities due to the increased pressure on them created by the higher velocity fluid flow over their control surfaces. Stabilization solutions at anchor or at low speed include actively-controlled fins (such as the stabilization at rest system developed by Rolls Royce that oscillate to counteract wave motion), and rotary cylinders employing the Magnus effect (developed by Quantum Med Marine under the MagLift™ Zero Speed™ name). The latter two systems are also retractable, allowing for a thinner vessel profile when docking, and reduced drag while cruising.

Active fin stabilizers are normally used to reduce the roll that a vessel experiences while under way or, more recently, while at rest. The fins extend beyond the hull of the vessel below the waterline and alter their angle of attack depending upon heel angle and rate-of-roll of the vessel. They operate similar to airplane ailerons. Cruise ships and yachts frequently use this type of stabilizer system.

In an active fin stabilizer system, the angle of attack of a ship's stabilizer fins may be changed using, for example, hydraulic actuation systems, in order to increase or decrease the force created by the fin. It is easily understood that increasing the angle of attack may also result in increased turbulence in the fluid flow over the fin's control surfaces, resulting in increased drag and lowering the fuel efficiency of the vessel. As fuel costs are a significant component of the total costs of seaborne transportation, any reduction in fuel efficiency is undesirable. Further, even minimal angles of attack in prior art fins result in turbulence because of the shape of the fins of the prior art tend to comprise simple structures such as elongate fins of teardrop cross section.

Another significant cause of increased drag of fin stabilizers is the buildup of organic material that causes increased resistance to fluid flow, and thus increased drag. This is a significant problem and one that takes almost constant maintenance to address. Typically, bio fouling is removed by mechanical and/or chemical means, or a combination of both.

It can be seen that an improvement in the shape of ship fin stabilizers, and improvements in reducing or preventing bio-fouling, that result in reduced turbulence and thus reduced overall drag would greatly desired. The present invention, which comprises a novel and efficient anti-fouling and fluid dynamically efficient covering for structures such as fin stabilizers, and which also includes a method of manufacture and assembly of same, overcomes the disadvantages of the prior art. The fin stabilizer covering of the present invention presents a novel exoskeleton that results in less turbulence when deployed, and thus results in increase fuel efficiency overall.

### BRIEF SUMMARY OF THE INVENTION

The present invention comprises a system and/or method that has one or more of the following features and/or steps, which alone or in any combination may comprise patentable subject matter.

The present invention is a protective covering that may be applied onto a structure either at time of manufacture or as a retrofit. One purpose of the present invention is to enhance the hydrodynamic, bio-fouling and corrosion characteristics of a structure, for example but not limited to the hydrodynamic control surfaces of a ship such as, for example, ship roll stabilizers. This structure may be any object that is immersed in a fluid environment, such as an aqueous environment, where the enhancement of fluid dynamic, bio-fouling, and corrosion characteristics of the structure and it's surfaces would be advantageous. Examples of such structures are stabilizers for ships and submarines, wings for towed sonar arrays, vortex shedding devices for risers and moorings in the offshore oil industry and like structures, especially those structures that experience significant fluid flow or are deployed in corrosive environments. The structure to be improved may also be, for example, lateral and depth control wings for acoustic streamers, horizontal stabilizers, hydrofoils, hydroplanes, diving planes, rudders or any other immersed body where bio-fouling and/or hydrodynamic drag is of concern.

The invention comprises novel material selections for the skin and/or exoskeleton to reduce bio-fouling and corrosion with existing technologies in combination with drag-reducing turbulence-reducing shapes such as wavy leading edges, channels and/or riblets to result fluid dynamic characteristics that are superior to the materials and shapes of the prior art. One aspect of the novelty of the invention is the combination of both the prevention of bio-fouling and corrosion with hydrodynamic efficiency into one device that can be installed initially or may be retrofit as a skin and/or exoskeleton of an existing structure.

BRIEF DESCRIPTION OF THE FIGURES OF THE DRAWINGS

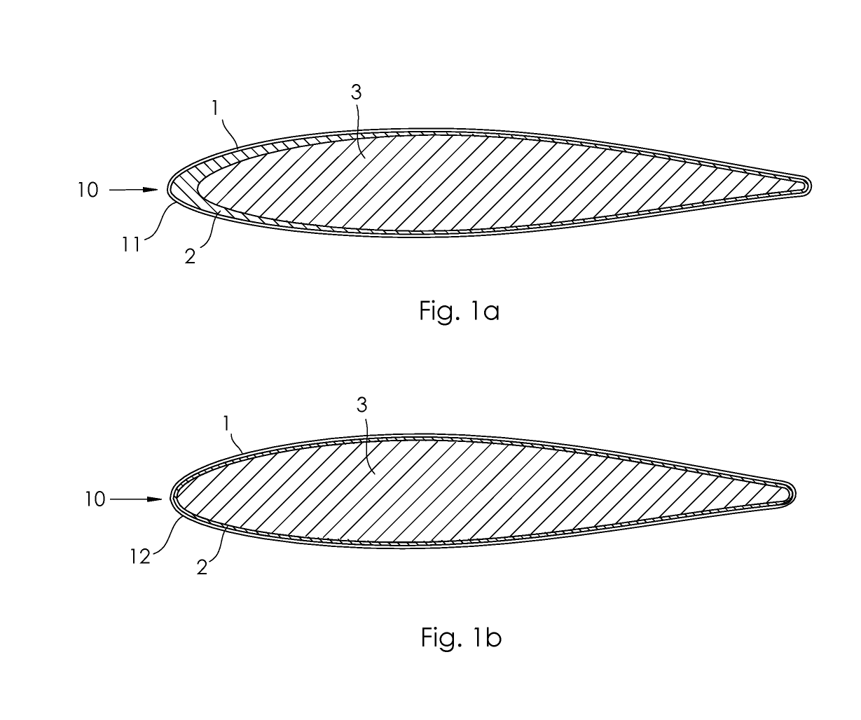

FIG. 1a depicts a side cross sectional view of a preferred embodiment of the invention, in which the layers of the exoskeleton of the invention are shown with a cross section taken through a peak on the leading edge of the invention.

FIG. 1b depicts a side cross sectional view of a preferred embodiment of the invention, in which the layers of the exoskeleton of the invention are shown with a cross section taken through a valley on the leading edge of the invention.

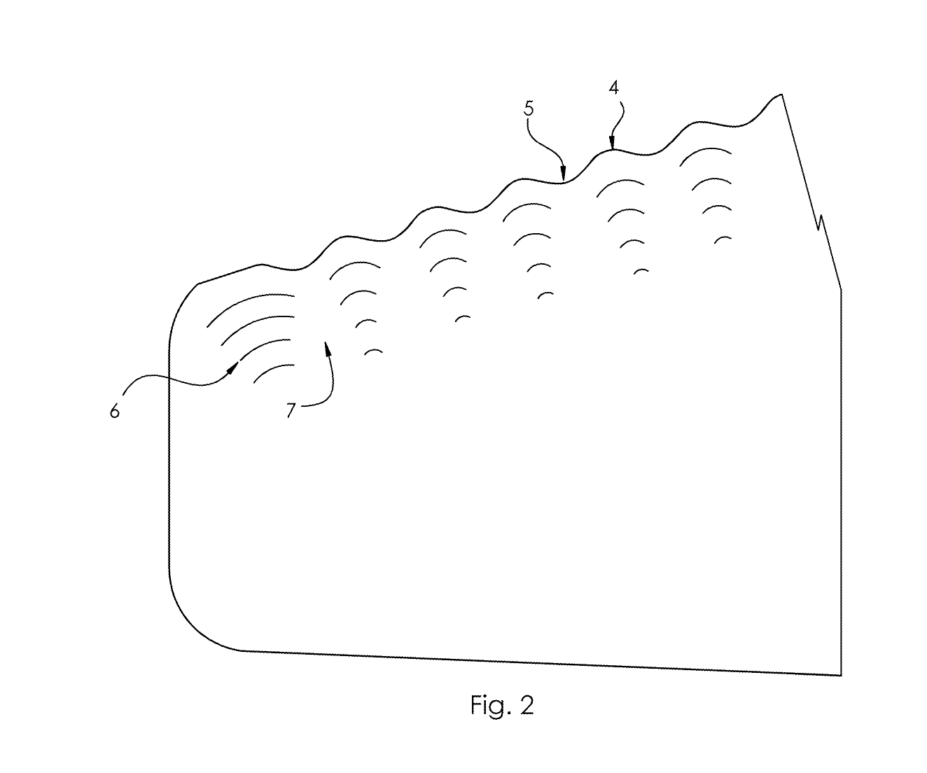

FIG. 2 depicts a top view of a first embodiment of the invention, comprising a leading edge comprised of fluid control elements in the form of crests and valleys.

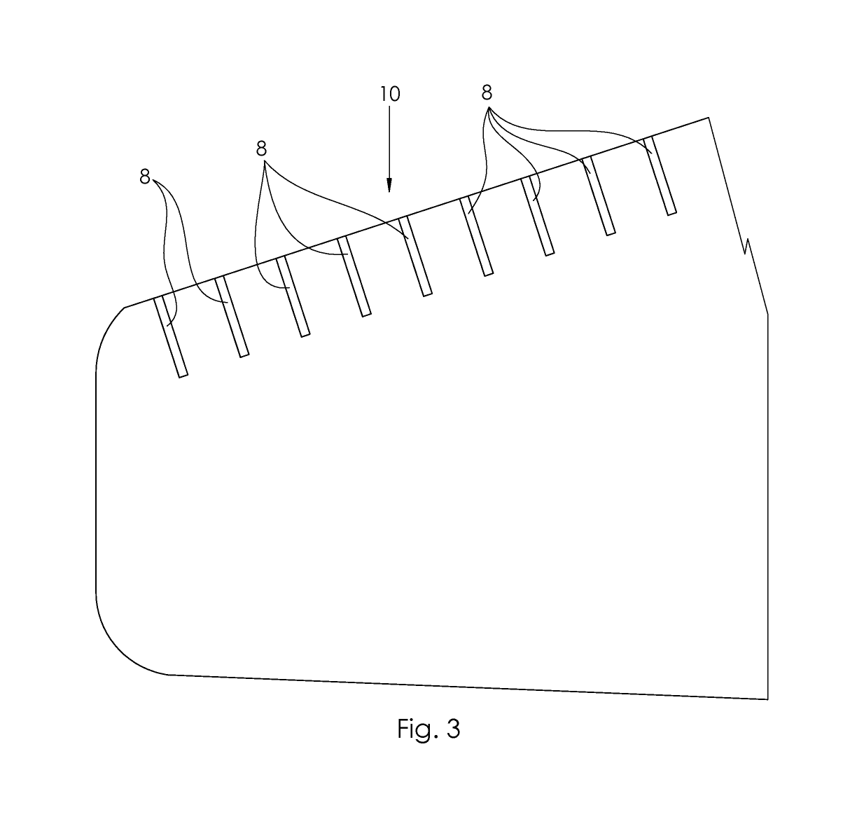

FIG. 3 depicts a top view of a second embodiment of the invention, comprising a leading-edge further comprised of fluid control elements in the form of hydrodynamic grooves.

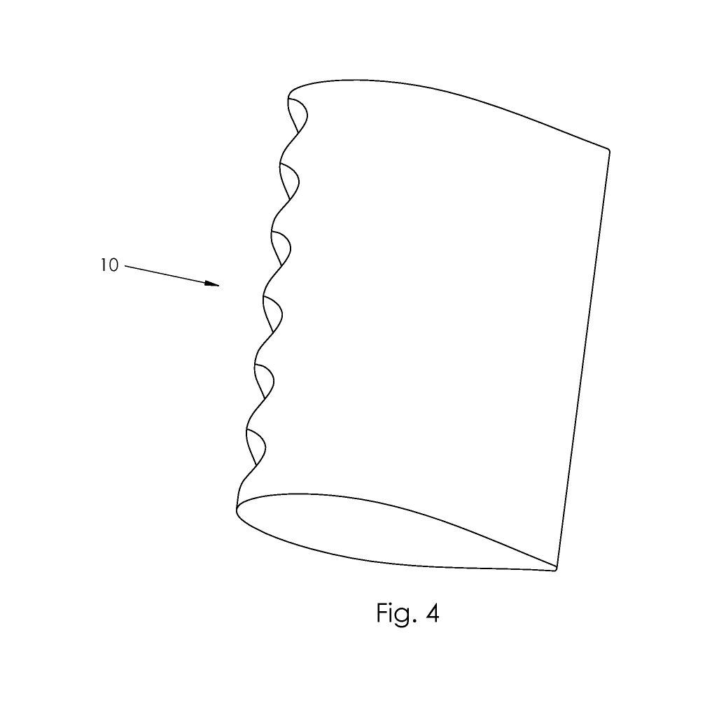

FIG. 4 depicts a perspective top view of a first embodiment of the invention, comprising a leading edge comprised of fluid control elements in the form of crests and valleys.

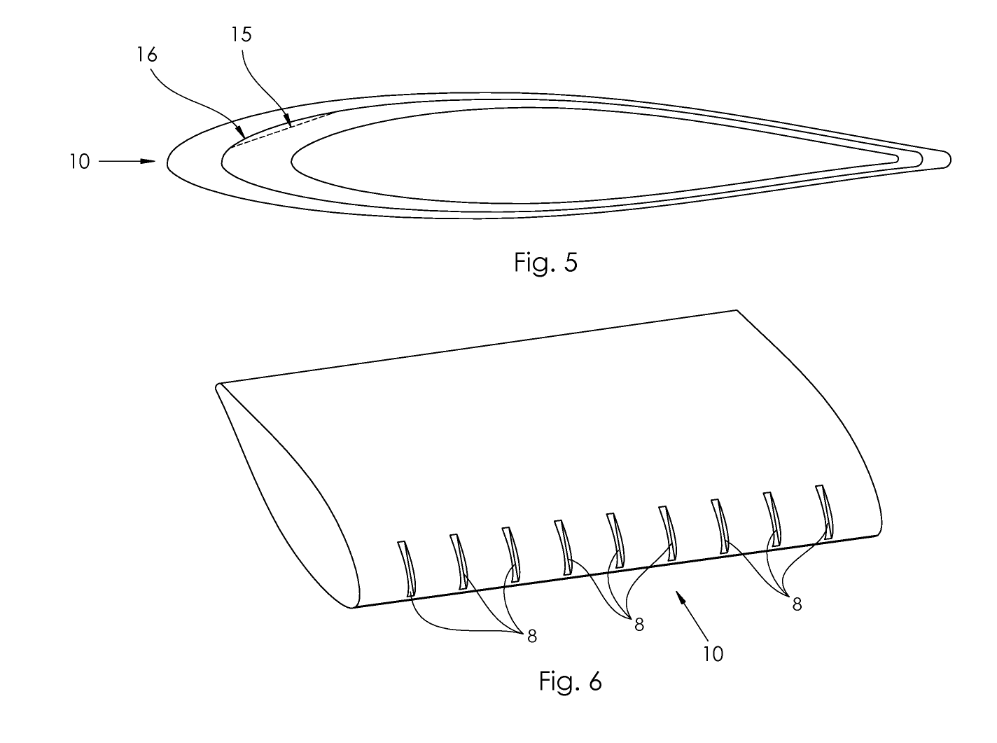

FIG. 5 depicts a cross sectional view of a third embodiment of the invention, comprising a leading edge further comprised of fluid control elements in the form of crests and valleys combined with grooves.

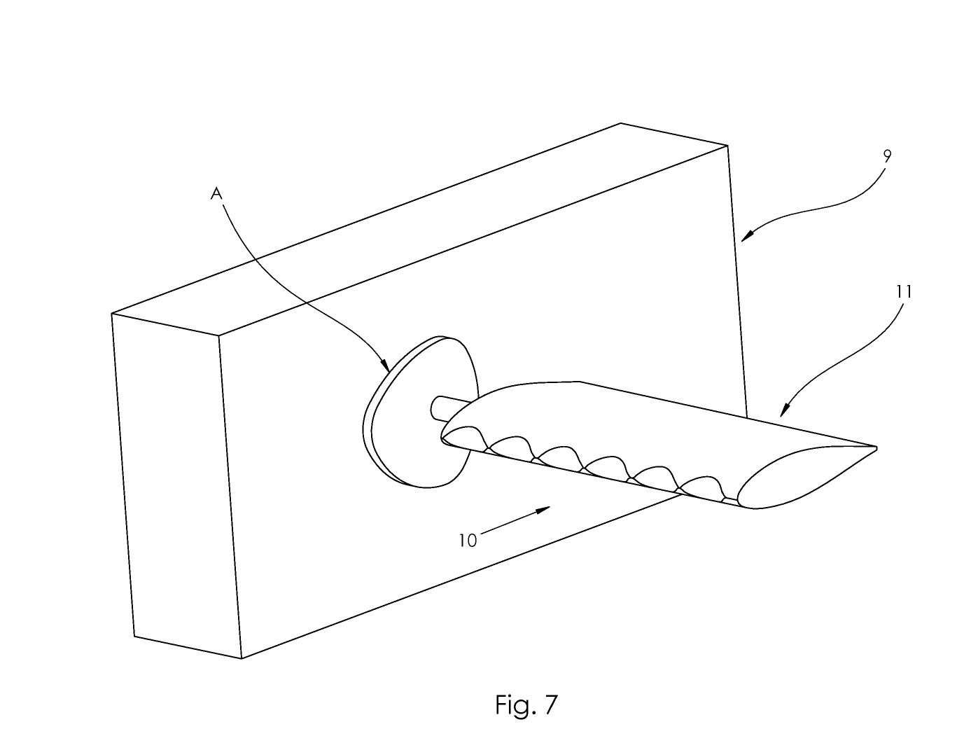

FIG. 6 depicts a cross sectional view of a second embodiment of the invention, comprising a leading-edge further comprised of fluid control elements in the form of hydrodynamic grooves.

FIG. 7 depicts a perspective view of the anti-fouling covering of the invention installed on a typical ship stabilizer.

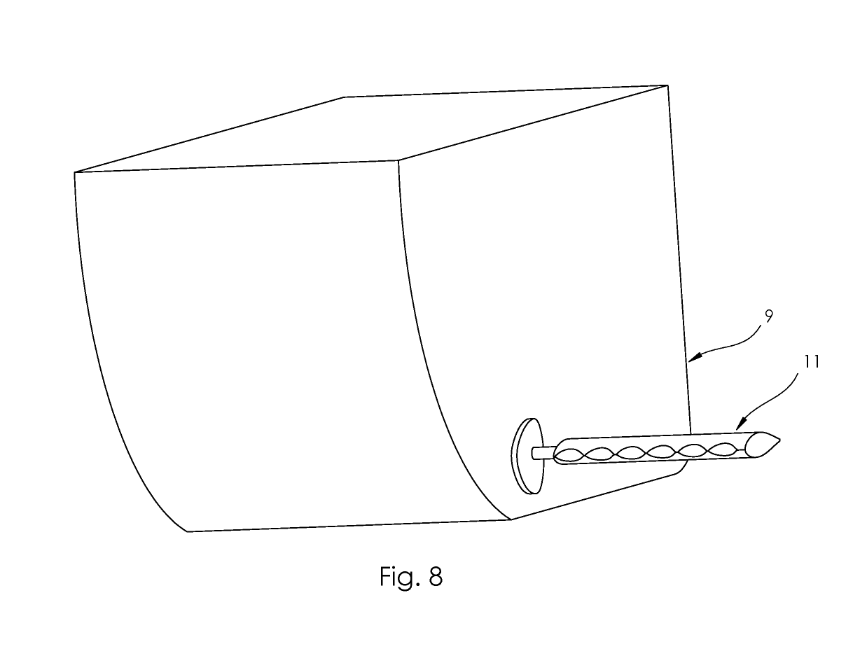

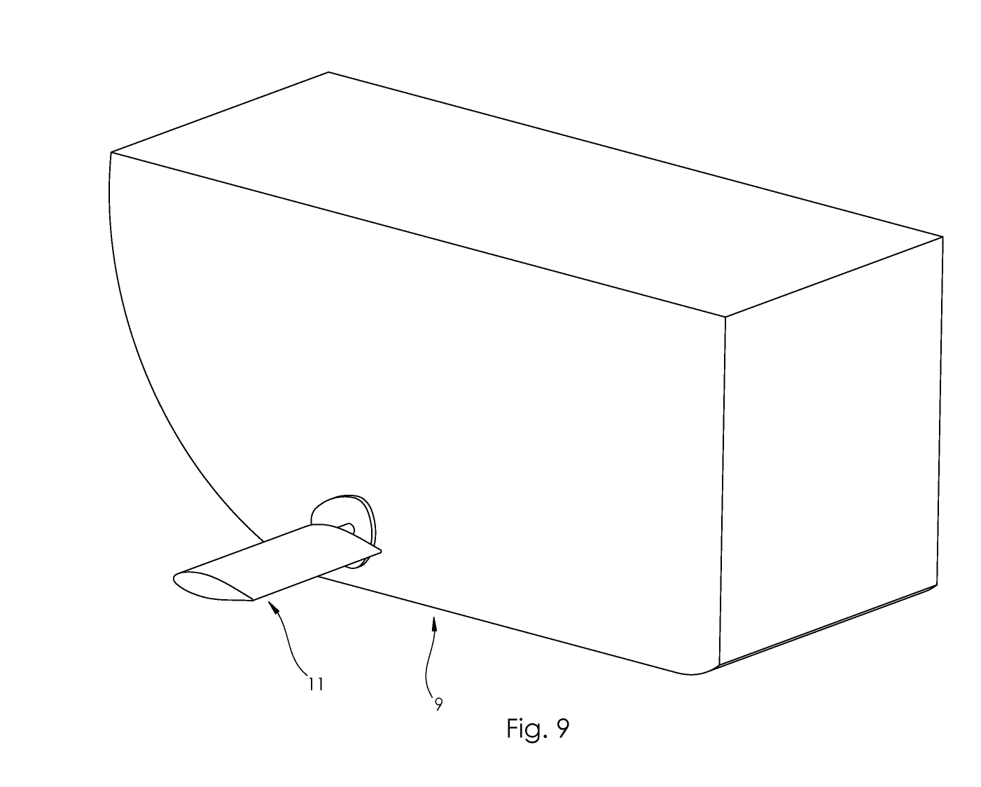

FIG. 8 depicts a further perspective view of the anti-fouling covering of the invention installed on a typical ship stabilizer.

FIG. 9 depicts a further perspective view of the anti-fouling covering of the invention installed on a typical ship stabilizer.

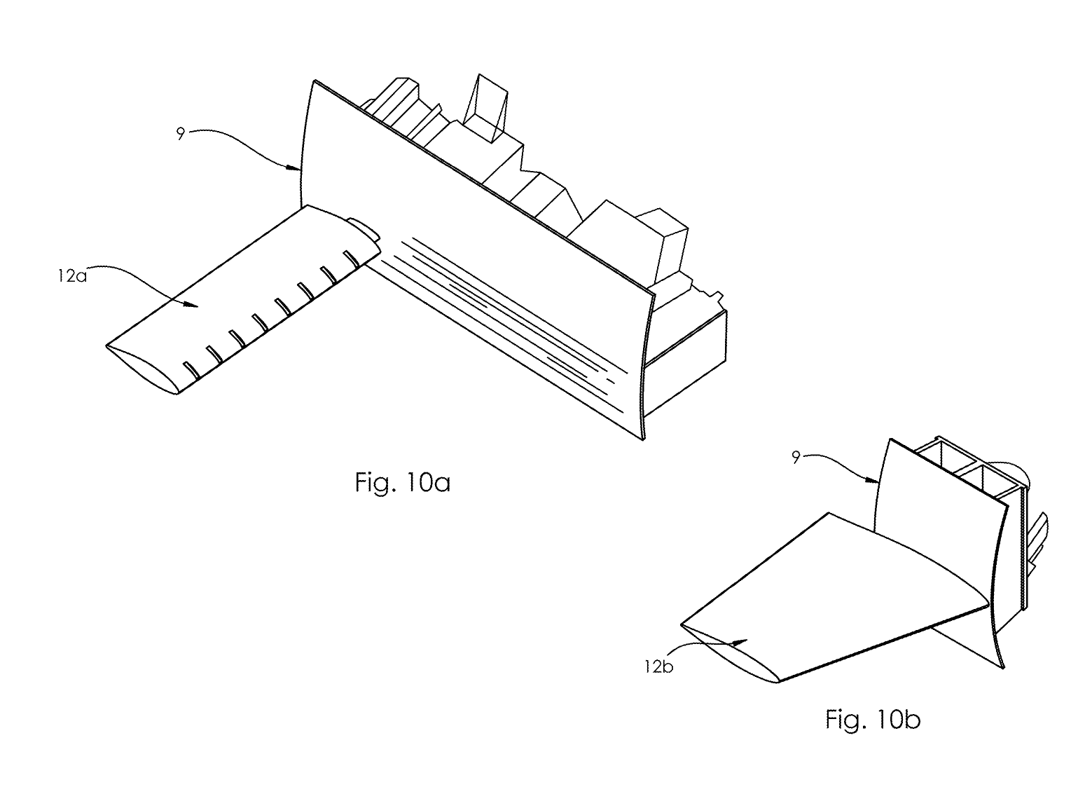

FIG. 10a depicts a perspective view of a ship stabilizer that is capable of lateral translation and rotation.

FIG. 10b depicts a perspective view of a ship stabilizer that is capable of rotation.

### DETAILED DESCRIPTION OF THE INVENTION

The following documentation provides a detailed description of the invention.

Although a detailed description as provided in the attachments contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not by the examples given.

Referring now to FIGS. 1a and 1b, cross-sections of the improved efficient surface covering of the invention are depicted. The invention may comprise an outer layer 1 disposed over an inner layer 2. Inner layer 2 is disposed over the structure to be improved 3, which may be any structure such as, for example, a ship stabilizer but is not necessarily limited to a ship stabilizer. As used herein, “structure to be improved” shall be synonymous with “structure to be covered”. Inner layer 2 may have an inner surface that is conformal contact with a structure to be covered, and may have an outer surface that is in conformal contact with an inner surface of outer layer 1. In a preferred embodiment, outer layer 1 comprises a anti-biofouling material such, as for example, polydimethylsiloxane elastomer (“PDMS”) or any polymeric organosilicon material that exhibits hydrophobic, fouling release and biological growth resistance properties such that the structure is able to move through a fluid environment, such as water, without the increased resistance caused by the buildup of biologic growth on the outer surface of outer layer 1. The biological growth resistance properties of outer layer 1 serve to inhibit and/or prevent the build-up of biologic and/or organic material on its outer surface, and thus reduces or eliminates the increased drag associated with a build-up of biological and/or organic material over time on fluid control surfaces, especially those surfaces that are in or near water. The leading edge of inner layer 2 corresponding to a peak is shown as item 11 in FIG. 1. The leading edge of inner layer 2 corresponding to a valley is shown as a hidden line 12 in FIG. 1. As shown in FIG. 1, the peaks and valleys may be formed in layer 2, and layer 1 may conform to layer 2. Fluid flow 10 is shown directed into the leading edge of the structure.

As used herein, the term “structure”, “structure to be covered” or “structure to be improved” may be any structure subjected to a fluid flow. While the description of the invention set forth in this patent application is primarily directed to control surfaces such as ship stabilizers, it is to be understood that the invention may be applied to any surface that is subjected to fluid flow.

Still referring to FIG. 1, inner layer 2 is preferably comprised of a fabric, composite, an elastomer or any combination thereof that is adapted to cover the structure such that inner layer 2 conforms to the shape of the structure to be improved 3 and may require curing, heating, cross-linking or other treatment after fitting over the structure to be improved in order to conform to the structure. As an example, and not by way of limitation, inner layer 2 may be comprised fiber reinforced plastic, synthetic rubbers such as neoprene or high modulus toughened silicone or similar materials. Neoprene, as used herein, means any synthetic rubber including but not limited to polychloroprene. It is to be understood that the layers of the invention as depicted in FIG. 1 may be of any thickness. For example, certain applications may require thin cross-sections that provide desired elastic characteristics in order to tightly conform to specific protuberances or other particular release of the underlying structure to be improved. In other applications, thicker cross-sections may be adequate and provide improved durability or other structural characteristics as desired by the user. It is understood that the selection of the specific cross-section of material may be application-dependent. Furthermore, the properties of the fabric, composite, elastomeric, or any combination thereof, inner layer 2 may be selected to provide a desired coefficient of friction between the layers of the invention so as to prevent delamination, movement between layers, or other undesired characteristics.

Referring now to FIG. 2, a top view of a first embodiment of the invention, comprising a wavy leading edge configuration, is depicted. In this first embodiment, the leading-edge of the structure has been modified by the outer layer 1 of the present invention so as to present a plurality of fluid control surfaces in the form of valleys and peaks disposed along the leading edge of the structure. The structure is oriented such that fluid flow 10 is directed over the surfaces of the structure. Peaks 4 may be in substantial alignment with crests 6 and valleys 5 may be in substantial alignment with troughs 7 such that an alternating pattern of crests and troughs are formed on the exterior surface of the leading edge of the structure to be improved. Furthermore, the height of each crest and the depth of each trough may be of reduced amplitude as said crests 6 and troughs 7 extend away from the leading edge of the structure. In this manner, the leading-edge of the structure to be improved 3 to which the invention is applied may be modified to present a leading edge shape that is similar to naturally occurring shapes such as whale fins and the like. Such naturally occurring shapes exhibit desirable reduced turbulence characteristics, resulting in reduced drag on the structure to be improved. It is to be noted that the height, depth, and length of crests 6 and troughs 7 may be of any dimension desired to achieve improved fluid dynamic properties such as reduced turbulence and reduced drag. Likewise, any number of crests 6 and troughs 7 may comprise the present invention.

Referring now to FIG. 3, a top view of a second embodiment of the invention, comprising a series of hydrodynamic grooves, is depicted. In this second embodiment, the leading edge of the structure has been modified by outer layer 1 of the present invention so as to present a plurality of hydrodynamic grooves disposed along the leading edge of the structure to an oncoming fluid flow. The structure is oriented such that fluid flow 10 is directed over the surfaces of the structure. In this embodiment of the invention, at least one or a plurality of grooves 8 may be disposed along the leading-edge of the structure to be improved 3 and may be of any width or depth desired in order to achieve improved fluid dynamic properties such as reduced turbulence and reduced drag. Likewise, the length of grooves 8 may be any length desired to achieve the same effects.

Referring now to FIG. 4, a perspective top view of a first embodiment of the invention, comprising a leading edge comprised of fluid control elements in the form of crests and valleys, is depicted. Fluid flow 10 is depicted directed into the leading edge of the structure.

Referring now to FIG. 5, a side view of a first embodiment of the anti-fouling surface cover of the invention is depicted. As can be seen in the figure Layer 1 may conform to Layer 2. The leading edge of Layer 2 may comprise at least one groove 8, or a plurality of grooves 8, as indicated by the dashed line. Fluid flow 10 is directed into the leading edge of the structure as is indicated by the arrow in the figure.

Referring now to FIG. 6, a perspective view of the structure depicts one embodiment of at least one groove or plurality of grooves 8 in the leading edge of the structure. Fluid flow 10 is directed into the leading edge of the structure covered by the anti-fouling covering of the invention.

Referring now to FIG. 7, a perspective view of the invention installed on a typical ship stabilizer is depicted. A ship stabilizer with the covering of the invention 11 is installed on a ship, the hull of which is partially depicted as 9 in FIG. 7. The ship stabilizer with the covering of the invention 11 may be rotatably attached to ship hull 9, and thus may rotate as shown by arrow A in FIG. 7.

Referring now to FIGS. 8 and 9, the anti-fouling covering of the invention is shown installed on a typical ship stabilizer. The anti-fouling covering of the invention is installed on ship stabilizer 11, which may be attached to ship hull 9 by any means known in the art.

Referring now to FIG. 10a a perspective view of a ship stabilizer of the prior art that is capable of lateral translation and rotation is depicted. FIG. 10b depicts a perspective view of a ship stabilizer of the prior art that is capable of rotation. Ship hull 9 houses rotation and/or translation structure in order to rotate and/or translate ship stabilizer 12a which may be covered by the anti-fouling covering of the invention, or ship hull 9 may house rotation structure in order to rotate and/or translate ship stabilizer 12b which may be covered by the anti-fouling covering of the invention.

In a yet further alternate embodiment, the invention, which may comprise any combination of the fluid control elements described herein such as the crests and valleys hereinbefore described, hydrodynamic grooves and the like, may be applied over an active structure such as an active fin stabilizer. Such active structures may comprise both a static structure and a dynamic structure or may comprise either a static or dynamic structure. In some applications, the invention may be applied separately to the static structure and separately to the dynamic structure in order to provide complete covering of the active fan stabilizer.

The improved efficient control surface covering of the invention may comprise any number of layers of fabric, composite, elastomeric, or combinations thereof, inner layers and silicone-based polymer outer layers. While the figures of the drawings may depict a preferred embodiment of the invention comprising two layers, any number of layers may be used.

The invention may be manufactured and installed on a structure using the following method. First, inner layer 2, which comprises the improved hydrodynamic shapes and surface structures, may be manufactured. This may be accomplished by directly shaping the surface of inner layer 2 to the contours required for improved hydrodynamic performance using such means as machining or any other means for producing such a structure known in the art, or by the manufacture and use of a mold that has the aforementioned hydrodynamic form(s) in which inner layer 2 may be molded, cast, laid up or otherwise formed. In the case of direct shaping of the surface of inner layer 2, the PDMS fouling release surface may be applied using conformal coating techniques such as spraying or brushing. In the case of using a mold method of manufacture of inner layer 2, the fouling release PDMS material may form the outer layer and take on the desired hydrodynamic form. The thickness of this layer may be selected to provide the optimum rigidity required by the structures using the known properties of the materials used taking into consideration the hydrodynamic conditions expected to be experienced by the invention in the anticipated environment(s). The outer PDMS layer may cover inner layer 2, which may be a more rigid elastomer or composite material such as a fiber reinforced polymer that may form the shape of the structure to be covered. The preformed layers comprising the hydrodynamic shapes may then be applied to the control surfaces using an adhesive agent, heat shrink process, mechanical means or any other known means of attachment known in the art. The invention may be held in place over the structure through mechanical means such as mechanical fasteners, chemical bonding, or physical means such as a slight compressive fit between the inner surface of inner layer 2 and the structure to be covered.

The invention can be installed to fluid dynamic surfaces at time of manufacture or as a retrofit to provide a protective, anti-biofouling covering.

It can be seen that the invention reduces corrosion and bio-fouling and improves the fluid dynamic characteristics of an immersed streamlined body, such as a ship stabilizer fin, through passive means. The invention may be installed on a structure at the time of manufacture or as a retrofit effort. In this manner the invention is adaptable to virtually any structure.

I claim:

1. An anti-biofouling covering for a structure comprising:
an inner layer having an inner surface and an outer surface, said inner surface of said inner layer disposed in conformal contact with a structure to be covered; and
an outer layer having an inner surface and an outer surface, wherein said inner surface of said outer layer is in conformal contact with said outer surface of said inner layer, and
wherein said outer covering comprises an anti-biofouling material.

2. The anti-biofouling covering for structures as in claim 1, wherein said inner layer comprises a material selected from the group consisting of a fabric material, a composite material, a synthetic rubber and an elastomeric material.

3. The anti-biofouling covering for structures as in claim 1, wherein said outer layer comprises a silicone based polymer.

4. The anti-biofouling covering for structures as in claim 3, wherein said outer layer silicone based polymer is further defined as a polymeric organosilicon material.

5. The anti-biofouling covering for structures as in claim 1, wherein said outer layer comprises a polydimethylsiloxane elastomer.

6. The anti-biofouling covering for structures as in claim 2, wherein said outer layer comprises a silicone based polymer.

7. The anti-biofouling covering for structures as in claim 6, wherein said silicone based polymer is further defined as a polymeric organosilicon material.

8. The anti-biofouling covering for structures as in claim 2, wherein said outer layer comprises a polydimethylsiloxane elastomer.

9. The anti-biofouling covering for structures as in claim 1, wherein said inner layer further comprises a leading edge relative to a fluid flow, said leading edge comprising a plurality of alternating crests and troughs.

10. The anti-biofouling covering for structures as in claim 1, wherein said inner layer further comprises a leading edge relative to a fluid flow, said leading edge comprising at least one hydrodynamic groove.

11. A method for manufacturing an anti-biofouling covering for a structure, comprising the steps of:
fabricating an inner layer having an inner surface forming a complimentary shape to a structure to be covered, wherein said inner layer has an outer surface and wherein said inner comprises material selected from the group consisting of a fabric material, a composite material or an elastomeric material, and wherein said inner layer is formed by molding, casting, machining, or laying up; and
forming an outer layer on said outer surface of said inner layer applying a conformal coating of anti-biofouling material onto said outer surface of said inner layer.

12. The method of claim 11 in which said outer layer comprises a a polydimethylsiloxane elastomer.

13. The method of claim 12 in which said outer layer comprises a silicone based polymer.

14. The method of claim 11 wherein said step of applying is further defined as applying by spraying.

15. The method of claim 12 wherein said step of applying is further defined as applying by spraying.

16. The method of claim 13 wherein said step of applying is further defined as applying by spraying.

17. The method of claim 11 wherein said step of applying is further defined as applying by brushing.

18. The method of claim 12 wherein said step of applying is further defined as applying by brushing.

19. The method of claim 13 wherein said step of applying is further defined as applying by brushing.

20. The method of claim 11 further comprising the step of attaching said inner surface of said inner layer to a structure to be covered, wherein said attachment comprises chemical bonding.

21. The method of claim 12, further comprising the step of attaching said inner surface of said inner layer to a structure to be covered, wherein said attachment comprises chemical bonding.

22. The method of claim 13, further comprising the step of attaching said inner surface of said inner layer to a structure to be covered, wherein said attachment comprises chemical bonding.
